(19) United States
(12) Patent Application Publication
(10) Pub. No.: US 2014/0245179 A1
(43) Pub. Date: Aug. 28, 2014

(54) METHOD AND APPARATUS FOR DETERMINING GROUP DECISION POINTS DURING A GROUP COMMUNICATION SESSION

(71) Applicant: NOKIA CORPORATION, Espoo (FI)

(72) Inventors: GOPALAKRISHNA RAGHAVAN, Espoo (FI); ASHWINKUMAR NADAGOUDAR, Espoo (FI)

(73) Assignee: NOKIA CORPORATION, Espoo (FI)

(21) Appl. No.: 13/774,322

(22) Filed: Feb. 22, 2013

(51) Int. Cl. H04L 29/06

(52) U.S. Cl. CPC H04L 65/403
USPC 715/753

(57) ABSTRACT

An approach is provided for determining one or more group decision points based, at least in part, on user preference information during a group communication session. A coordination platform determines a request for presenting one or more group decision points in a conversation user interface of a group communication session. The coordination platform causes, at least in part, a presentation of at least one decision point user interface element in the conversation user interface, wherein the at least one decision point user interface element presents one or more parameters associated with the one or more group decision points for one or more interactions by one or more members of the group communication session. The coordination platform further processes and/or facilitates a processing of the one or more interactions to cause, at least in part, a fixing of at least one outcome of the one or more group decision points for the one or more members.

### BACKGROUND

Service providers and device manufacturers (e.g., wireless, cellular, etc.) are continually challenged to deliver value and convenience to consumers by, for example, providing compelling network services. Time and again, mobile device users desire to engage in group based interaction with other mobile device users. The overall quality of experience of a mobile device user as they engage with others in a collaborative networking environment depends on various factors. For instance, the extent to which a coordinated group decision points may be determined within a collaborative network environment. However, in a typical network services, decisions may be centrally controlled by the organizer, and lacks interaction between the group members in the decision making process. Consequently, user experience associated with such services is negatively affected. On the other hand, in a conventional social networking environment, there may be influx of opinions pertaining to group decision points resulting in uncoordinated decisions making. Henceforth, rendering the decision making process prolonged and tedious.

### SOME EXAMPLE EMBODIMENTS

Therefore, there is a need for an approach for determining one or more group decision points based, at least in part, on user preference information during a group communication session.

According to one embodiment, a method comprises determining a request for presenting one or more group decision points in a conversation user interface of a group communication session. The method also comprises causing, at least in part, a presentation of at least one decision point user interface element in the conversation user interface, wherein the at least one decision point user interface element presents one or more parameters associated with the one or more group decision points for one or more interactions by one or more members of the group communication session. The method further comprises processing and/or facilitating a processing of the one or more interactions to cause, at least in part, a fixing of at least one outcome of the one or more group decision points for the one or more members.

According to another embodiment, an apparatus comprises at least one processor, and at least one memory including computer program code for one or more computer programs, the at least one memory and the computer program code configured to, with the at least one processor, cause, at least in part, the apparatus to determine a request for presenting one or more group decision points in a conversation user interface of a group communication session. The apparatus also causes, at least in part, a presentation of at least one decision point user interface element in the conversation user interface, wherein the at least one decision point user interface element presents one or more parameters associated with the one or more group decision points for one or more interactions by one or more members of the group communication session. The apparatus is further caused to process and/or facilitate a processing of the one or more interactions to cause, at least in part, a fixing of at least one outcome of the one or more group decision points for the one or more members.

According to another embodiment, a computer-readable storage medium carries one or more sequences of one or more instructions which, when executed by one or more processors, cause, at least in part, an apparatus to determine a request for presenting one or more group decision points in a conversation user interface of a group communication session. The apparatus also causes, at least in part, a presentation of at least one decision point user interface element in the conversation user interface, wherein the at least one decision point user interface element presents one or more parameters associated with the one or more group decision points for one or more interactions by one or more members of the group communication session. The apparatus is further caused to process and/or facilitate a processing of the one or more interactions to cause, at least in part, a fixing of at least one outcome of the one or more group decision points for the one or more members.

According to another embodiment, an apparatus comprises means for determining a request for presenting one or more group decision points in a conversation user interface of a group communication session. The apparatus also comprises means for causing, at least in part, a presentation of at least one decision point user interface element in the conversation user interface, wherein the at least one decision point user interface element presents one or more parameters associated with the one or more group decision points for one or more interactions by one or more members of the group communication session. The apparatus further comprises means for processing and/or facilitating a processing of the one or more interactions to cause, at least in part, a fixing of at least one outcome of the one or more group decision points for the one or more members.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining one or more group decision points based, at least in part, on user preference information during a group communication session, according to one embodiment;

FIG. 2 is a diagram of the components of a coordination platform 109, according to one embodiment;

FIGS. 3-6 are flowcharts of processes for determining one or more group decision points based, at least in part, on user preference information during a group communication session, according to one embodiment;

FIGS. 7-11 are ladder diagrams that illustrates a sequence of processes used in determining one or more group decision points based, at least in part, on user preference information during a group communication session, according to various embodiments;

FIGS. 12A-12C are diagrams of user interfaces utilized in the processes of FIGS. 3-6, according to various embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for determining one or more group decision points based, at least in part, on user preference information during a group communication session are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

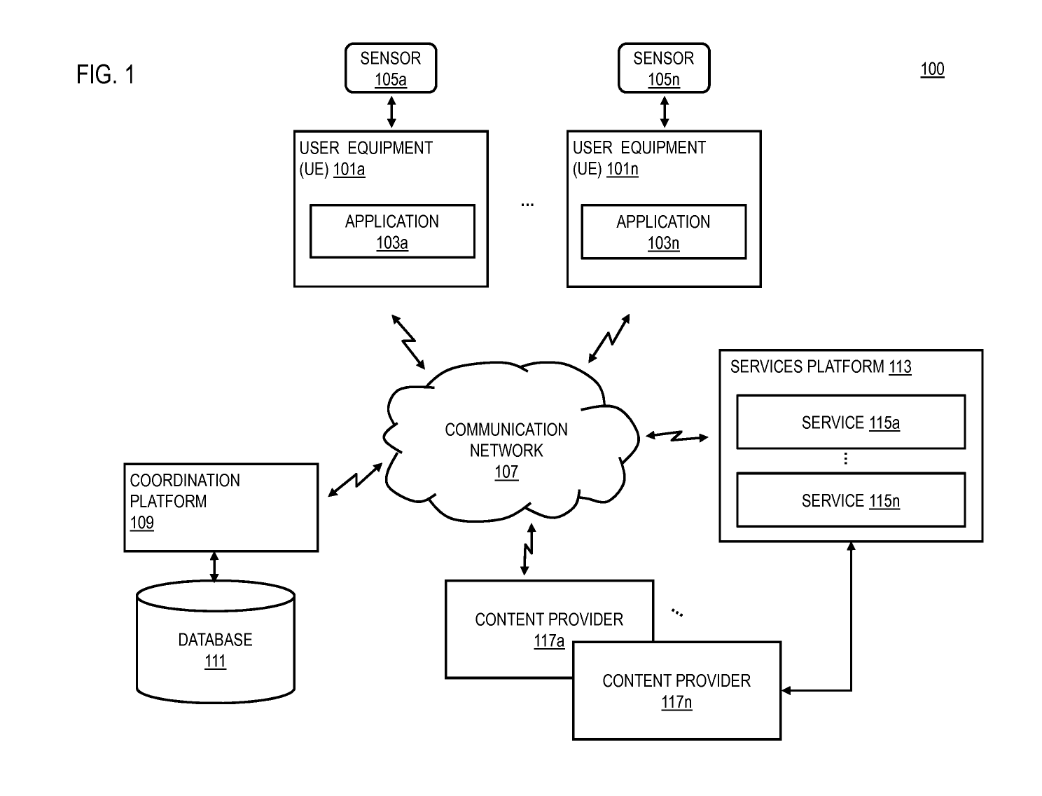

FIG. 1 is a diagram of a system capable of determining one or more group decision points based, at least in part, on user preference information during a group communication session, according to one embodiment. As mentioned, typical network services lack user involvement in decision making process, often resulting in decision being made by the administrator, hence leading to poor user experience associated with such services. In one scenario, members may have different preferences, as such, members who are presented with group decision points in a conversation user interface of a group communication session should be given an opportunity to express their opinion on the proposal, thereby increasing user participation. On the other hand, in a conventional social networking environment, participants are actively engaged in various conversations. If one of the participants recommends a group decision point, there may be an exchange of several messages between the participants before they can come to an agreement. As a result, rendering the decision making process unproductive.

To address these issues, a system 100 of FIG. 1 introduces the capability to determine one or more group decision points based, at least in part, on user preference information during a group communication session. As shown in FIG. 1, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UEs 101 have connectivity to coordination platform 109 via the communication network 107.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as media player applications, social networking applications, calendar applications, content provisioning services, location-based service applications, navigation applications and the like. In one embodiment, one of the applications 103 at the UE 101 may act as a client for coordination platform 109 and perform one or more functions associated with the functions of the coordination platform 109 by interacting with the coordination platform 109 over communication network 107.

By way of example, the sensors 105 may be any type of sensor. In certain embodiments, the sensors 105 may include, for example, a camera/imaging sensor for gathering image data, an audio recorder for gathering audio data, a global positioning sensor for gathering location data, a network detection sensor for detecting wireless signals or network data, temporal information and the like.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the coordination platform 109 may be a platform with multiple interconnected components. The coordination platform 109 may include multiple servers, intelligent networking devices, computing devices, components and corresponding software for performing the function of determining one or more group decision points based, at least in part, on user preference information during a group communication session. In addition, it is noted that the coordination platform 109 may be a separate entity of the system 100, a part of the one or more services 115 of the service platform 113, or included within the UE 101 (e.g., as part of the application 103).

In this way, the system 100 resolves problems associated with typical network services, for example, by allowing members to participate in a decision making process in a coordinated fashion and, thus, providing an approach for keeping members informed and for speeding up communication between the participants. In one scenario, for instance, Steve, Ray, Nick, Louise and John may be members to a group communication session, wherein Steve proposes a group decision point. The proposed group decision point may be presented by the coordination platform 109 in the conversation user interface of the respective members, wherein the decision point user interface presents one or more parameters, for instance, location information, time information, and any other description information. Such parameter may be used by Ray, Nick, Louise and John in making a decision, which may then be reflected in the preference information. If the entire members consent to the group decision point, then one of the members may fix the group decision points for the one or more members of the group communication session. On the other hand, if there are already ‘four out of five’ members who concede with the group decision point and the time parameter shows that the meetup is due in few hours, then one of the 4 members may go ahead and fix the group decision point. Upon fixing of the group decision point, the coordination platform 109 may enter the group decision point parameters into an application associated with the one or more members of the group communication session, thereby causing, at least in part, a notification of the group decision point based, at least in part, on the group decision point, application or a combination thereof.

In one scenario, for instance, Ray is presented with a request to give his feedback on the group decision point, and Ray chooses to recommend an alternate value, for instance, new timing parameter, or recommends another group decision point, the coordination platform 109 may use preference information received from Ray and cause another presentation of at least one other decision point user interface presenting the one or more alternate values for the one or more parameters for one or more other interactions by the one or more members.

In another scenario, if Steve fixes the group decision point, the coordination platform 109 allows any other members of the group communication session to unfix the group decision point based, at least in part, on the preference information. The any other members may fix a new group decision point, whereby the coordination platform 109 may cause, at least in part, a hiding of a decision point user interface element, the at least one other decision point user interface element, or a combination thereof that are not associated with the fixed at least one outcome.

In one embodiment, the coordination platform 109 may determine another input for specifying one or more parameters for initiating the presentation of the at least one group decision point. By way of example, the one or more parameters may include, at least in part, a location, a time, a description parameter, a lifetime parameter, or a combination thereof. In addition, in some embodiments, the lifetime parameter may be determined based, at least in part, on a manual input from the at least one member, a default value, a scheduled duration of the group communication session, or a combination thereof. In one scenario, for instance, the coordination platform 109 may prompt Steve to determine a lifetime parameter for the group decision point. As such, the presentation of the group decision point may have a defined lifetime after which the group decision point may no longer be displayed.

In one embodiment, the coordination platform 109 may include or have access to a database 111 to access or store any kind of data, such as historical user information, location proximity information, temporal proximity information, contextual proximity information, etc. Data stored in the database 111 may, for instance, be provided by the UEs 101, a service platform 113, one or more services 115a-115n (or services 115), or one or more content providers 117a-117n (or content providers 117).

In one embodiment, the services platform 113 may include any type of service. By way of example, the services platform 113 may include social networking services, content (e.g., text, images, etc.) provisioning services, application services, mapping services, navigation services, storage services, contextual information determination services, location based services, information (e.g., weather, news, etc.) based services, etc. In one embodiment, the services platform 113 may interact with the UE 101, the coordination platform 109 and the content providers 117 to supplement or aid in the processing of the content information. By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability.

The content providers 117 may provide content to the UE 101, the coordination platform 109, and the services 115 of the services platform 113. The content provided may be any type of content, such as textual content, image content, video content etc. In one embodiment, the content providers 117 may provide content that may supplement content of the applications 103, the sensors 105, or a combination thereof. In one embodiment, the content providers 117 may also store content associated with the UE 101, the coordination platform 109, and the services 115 of the services platform 113. In one embodiment, the content providers 117 may manage access to a central repository of data, and offer a consistent, standard interface to data. In another embodiment, the content providers 117 act as hosts of one or more websites, social networking services, blogs, advertising materials, review information, data feeds, or sources of other information and/or documents.

By way of example, the UE 101, the coordination platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

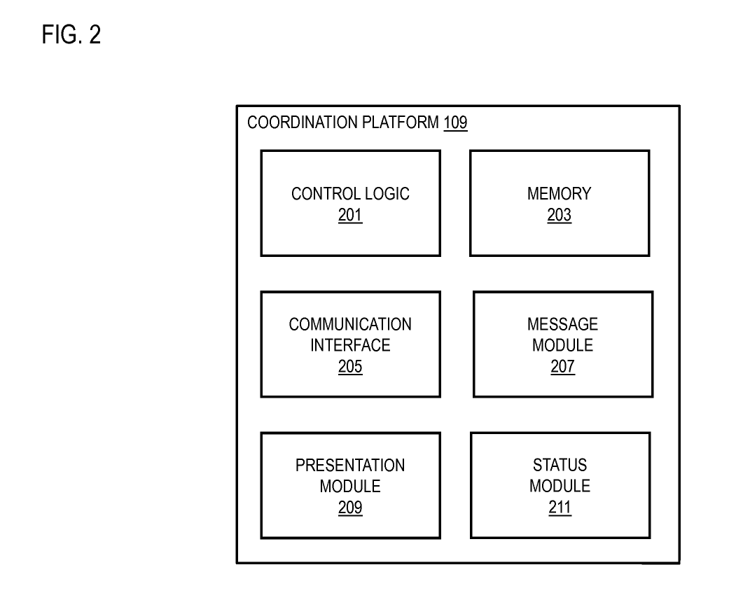

FIG. 2 is a diagram of the components of the coordination platform 109, according to one embodiment. By way of example, coordination platform 109 includes one or more components for determining one or more group decision points based, at least in part, on user preference information during a group communication session. As discussed above, it is contemplated that the functions of these components may be combined in one or more components or performed by other components of equivalent functionality. In this embodiment, the coordination platform 109 includes control logic 201, memory 203, a communication interface 205, a message module 207, a presentation module 209, and a status module 211.

The control logic 201 executes at least one algorithm for executing functions of the coordination platform 109. For example, the control logic 201 may interact with the communication interface 205 to enable formation of a group communication session over the communication network 107 between the UE 101, the coordination platform 109, the services platform 113, the services 115, the content providers 117, etc. The communication interface 205 may, for instance, execute various protocols and data sharing techniques for enabling collaborative execution between the UE 101, the coordination platform 109, and content provider 117 over the communication network 107.

The control logic 201 may also direct the message module 207 to determine an input for specifying a request for presenting one or more group decision points in a conversation user interface of a group communication session. In one scenario, for instance, during a text-based session one of the participants may propose a group decision point at a scheduled time. Based on the preference information from other members, the message module 207 may identify the one or more group decision points, and register with the presentation module 209 to cause presentation of the one or more group decision points to the other members. Further, the presentation module 209 may cause a presentation upon receiving the data from communication interface 205.

In certain embodiments, the presentation module 209 may utilize the status module 211 to determine preference information of other members to the group communication session. In one scenario, the status module 211 may provide the presentation module 209 with polling information, the number of time the members viewed the group decision points in the conversation interface etc.

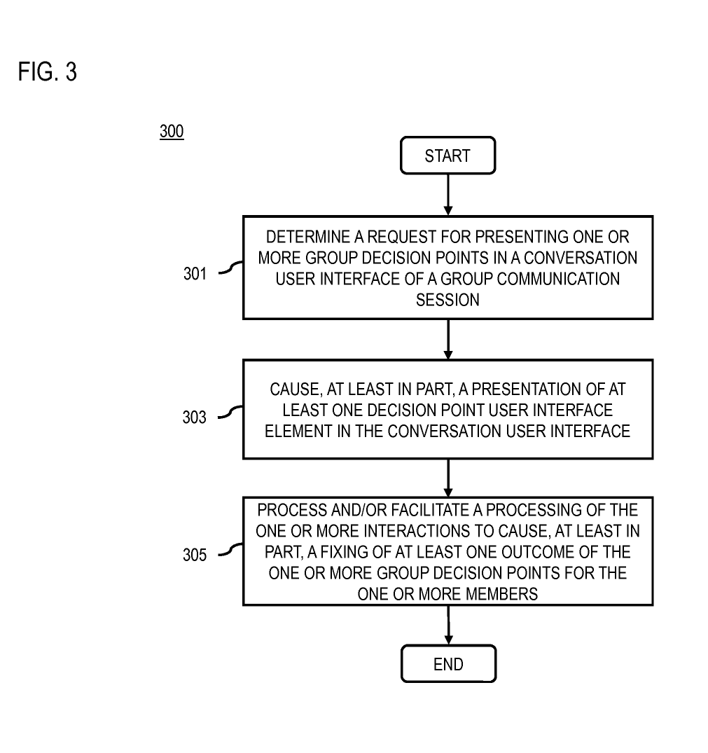

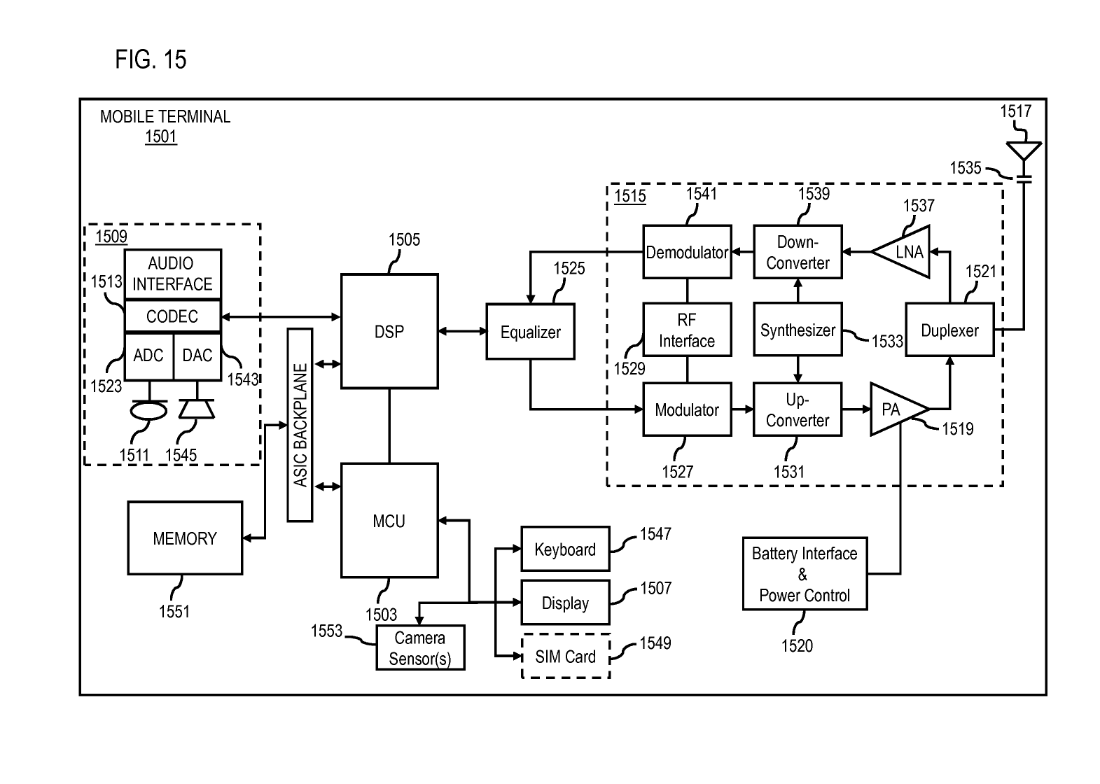

FIG. 3 is a flowchart of a process for determining one or more group decision points based, at least in part, on user preference information during a group communication session, according to one embodiment. In one embodiment, the coordination platform 109 performs the process 300 and is implemented in, for instance, a chip set including a processor and a memory as shown in FIG. 15.

In step 301, the coordination platform 109 determines a request for presenting one or more group decision points in a conversation user interface of a group communication session. In one scenario, during a group communication session, one of the members may proposition a group decision point, the group decision point may have various parameters, such as, time stamp, location information, visual information and the like. The coordination platform 109, may determine such request and may provide a detailed view of the request during the conversation between the group members, wherein the group members may give their preferences regarding the suggested group decision point.

In step 303, the coordination platform 109 causes, at least in part, a presentation of at least one decision point user interface element in the conversation user interface, wherein the at least one decision point user interface element presents one or more parameters associated with the one or more group decision points for one or more interactions by one or more members of the group communication session. In one embodiment, the one or more parameters include, at least in part, a location, a time, a description parameter, a lifetime parameter, or a combination thereof. In one scenario, group members may be engaged in different conversation, during the conversation one of the members may request for a meetup, the coordination platform 109 may display the meetup in the conversation user interface, wherein one or more parameters associated with the group decision point, such as, location information, time information, visual information and the like may be displayed for interactions by one or more members of the group. There is a detail view of every request and the feedback to the request from other members. It provides for a distributed communication in a social environment, where everybody may provide their preference information and the decision making process is not centralized because the control is distributed amongst the entire group.

In step 305, the coordination platform 109 processes and/or facilitates a processing of the one or more interactions to cause, at least in part, a fixing of at least one outcome of the one or more group decision points for the one or more members. In one embodiment, the one or more group decision points include, at least in part, one or more decisions related to coordinating a meetup among the one or more members. In one scenario, the coordination platform causes, at least in part, a presentation of the group decision point to coordinate a meetup between the group members. In one scenario, the coordination platform 109 may present the fixed group decision point to the members of the group communication session based, at least in part, on a determination that at least one of the members to the group communication session has finalized the proposed group decision point based, at least in part, on preference information.

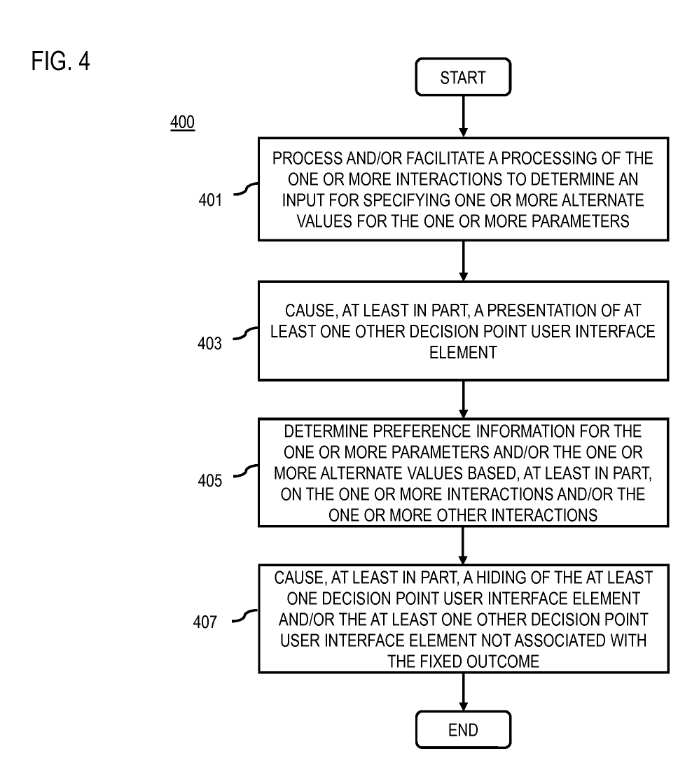

FIG. 4 is a flowchart of a process for determining preference information for the one or more parameter and/or the one or more alternate values based, at least in part, on the one or more interactions, according to one embodiment. In one embodiment, the coordination platform 109 performs the process 400 and is implemented in, for instance, a chip set including a processor and a memory as shown in FIG. 15.

In step 401, the coordination platform 109 processes and/or facilitates a processing of the one or more interactions to determine an input for specifying one or more alternate values for the one or more parameters. In one scenario, the members of the group communication session may see the displayed group decision points, whereby they may peruse through the parameters for the displayed group decision point and may accept, alter or replace the parameters. In one scenario, a member to a group communication session may propose a meeting destination at a certain time, whereas, the other member may propose a different time for the meeting. Subsequently, the coordination platform 109 may determine the member's input for specifying alternate values.

In step 403, the coordination platform 109 causes, at least in part, a presentation of at least one other decision point user interface element, wherein the at least one other decision point user interface element presents the one or more alternate values for the one or more parameters for one or more other interactions by the one or more members. In one scenario, the coordination platform may determine one or more alternate values, for instance, different time parameters, different location parameters and so on, based, at least in part, on user interactions, and may display the alternate value in the communication user interface for other members to see and give their preferences.

In step 405, the coordination platform 109 determines preference information for the one or more parameters, the one or more alternate values, or a combination thereof based, at least in part, on the one or more interactions, the one or more other interactions, or a combination thereof, wherein the fixing of the at least one outcome is further based, at least in part, on the preference information. In one embodiment, the fixing of the at least one outcome is based, at least in part, on a determination that the preference information indicates that the one or more members have reached at least one consensus threshold value with respect to the one or more group decision points. In one scenario, a list of the group decision points may be displayed above the conversation between the members, alongside the preference information, such as, polling information, the number of views, and so on. One of the members to the group communication session may fix one of the group decision points from the list based on preference information. In one scenario, seven out of ten members voted to meet at ABC restaurant at 6 p.m., instead of XYZ club and GHJ café. Therefore, one of the members may fix ABC restaurant as the group decision point based on majority preference and parameters. For instance, the member may fix a group decision point at a reasonable time before 6 p.m. giving all the attendees ample time to prepare accordingly. In one scenario, a parameter may have a lifetime parameter based, at least in part, on a manual input from the at least one participant, a default value, a scheduled duration of the group communication session, or a combination thereof.

In step 407, the coordination platform 109 causes, at least in part, a hiding of one or more of the at least one decision point user interface element, the at least one other decision point user interface element, or a combination thereof that are not associated with the fixed at least one outcome. As mentioned above, a member may fix a group decision point based, at least in part, on preference information. Once a decision point is fixed, the coordination platform 109 may cause a minimized view of the other decision points, namely XYZ club and GHJ café.

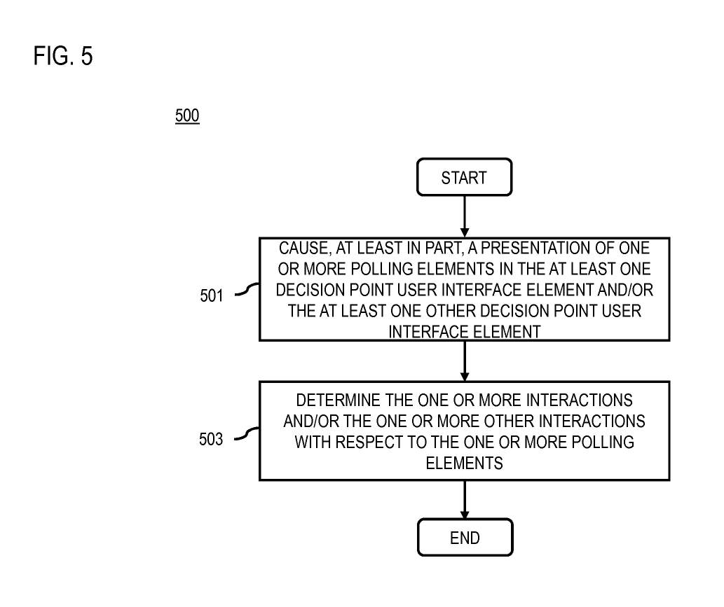

FIG. 5 is a flowchart of a process for determining one or more interactions and/or the one or more other interactions with respect to the one or more polling elements, according to one embodiment. In one embodiment, the coordination platform 109 performs the process 500 and is implemented in, for instance, a chip set including a processor and a memory as shown in FIG. 15.

In step 501, the coordination platform 109 causes, at least in part, a presentation of one or more polling elements in the at least one decision point user interface element, the at least one other decision point user interface element, or a combination thereof. In one scenario, a group decision point may be displayed during the conversation between the group members for them to see and express their opinion._Pursuant to the members providing their preference information, polling information representing the preference of the respective members may be displayed along with the group decision points in the conversation user interface. Further, alternative decision points may also be displayed along with their corresponding poll. The members may see the poll numbers and make suggestions on which group decision point to choose._Subsequently, one of the group member may fix the group decision point which may trigger an entry by the coordination platform 109 into an application associated with the one or more members of the group communication session, causing a notification of the group decision point based, at least in part, on the group decision point, application or a combination thereof.

In step 503, the coordination platform 109 determines the one or more interactions, the one or more other interactions, or a combination thereof with respect to the one or more polling elements. In one scenario, the coordination platform 109 may take into consideration the contextual information of the members to a group communication session through their respective UE 101, the polling information, the number of views the request for a group decision point has received, the number of likes for a group decision point and so on. In one scenario, polling may also be associated with number of responses (yes/no/maybe), whereby particiapants in the group may see the number of people who favors the meet-up. This process helps in fixing the decision making process.

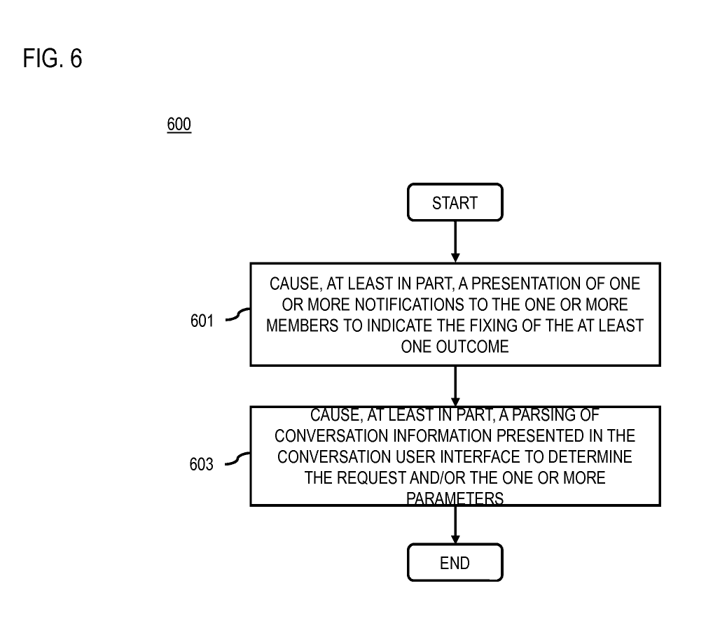

FIG. 6 is a flowchart of a process for causing a presentation of one or more notification indicating the fixing of the outcome and a parsing of conversation information to determine the request and/or the one or more parameters, according to one embodiment. In one embodiment, the coordination platform 109 performs the process 600 and is implemented in, for instance, a chip set including a processor and a memory as shown in FIG. 15.

In step 601, the coordination platform 109 causes, at least in part, a presentation of one or more notifications to the one or more members to indicate the fixing of the at least one outcome, wherein the one or more notifications include, at least in part, one or more options for unfixing the at least one outcome. In one scenario, fixing a group decision point may optionally hide the other group decision points. On the other hand, a group member may optionally unfix a group decision point, such action re-opens the opportunity for the group members to fix a new group decision point.

In step 603, the coordination platform 109 causes, at least in part, a parsing of conversation information presented in the conversation user interface to determine the request, the one or more parameters, or combination thereof. In one scenario, a member may propose a group decision point during a group conversation. Such request by one of the members may be processed by the coordination platform 109. Subsequently, the coordination platform 109 may cause a parsing of such request, thereby presenting the request for the group decision point in the communication user interface for the members to see and express.

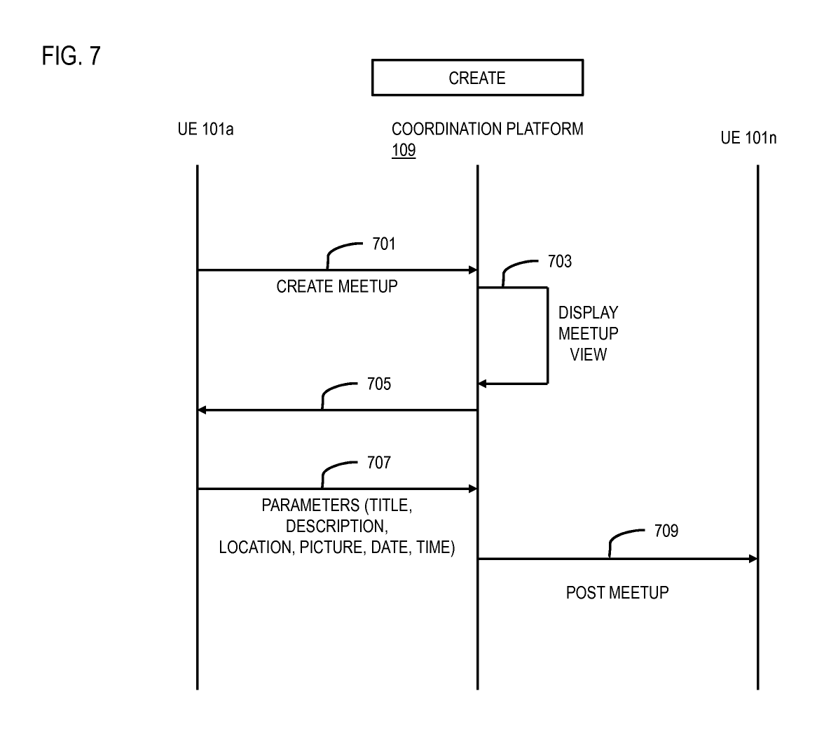

FIGS. 7-12 are ladder diagrams that illustrate a sequence of processes used in determining one or more group decision points based, at least in part, on user preference information during a group communication session, according to one embodiment. FIG. 7 is a ladder diagram that illustrates a sequence of process for presenting one or more group decision points in a conversation user interface of a group communication session. In step 701, a UE 101a generates a request for creating one or more group decision points and sends a request to the coordination platform 109. The coordination platform 109 retrieves the request of the UE 101a from the applications 103, the sensors 105 and processes the request to generate a display (Step 703). In step 705, the coordination platform 109 prompts the request sending UE 101a to input parameters for the one or more group decision points. Then, in step 707, the UE 101a provides the coordination platform 109 with a set of parameters (for example, title, description, location, place, picture, date, time etc.) Subsequently, the coordination platform 109 presents the generated request of the one or more group decision points to UE 101n during a group communication session.

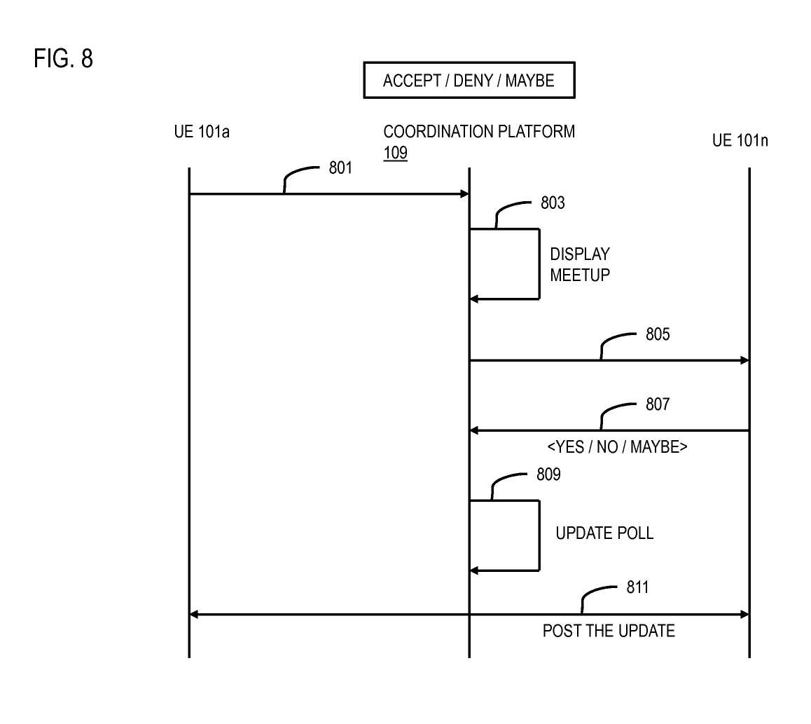

FIG. 8 is a ladder diagram that illustrates the sequence of process for determining one or more group decision points based, at least in part, on user preference information during a group communication session. In step 803, the coordination platform 109 processes the request 801 from UE 101a to generate a display for the one or more group decision points. The coordination platform 109 may display the one or more group decision points during a group communication session. The display can be but is not limited to, for example, texts, videos, photos, audio or a combination thereof. In step 805, the coordination platform 109 presents UE 101n with the option to choose the one or more group decision points. Subsequently, the coordination platform 109 may display the polling elements in the at least one decision point user interface element, if any. The coordination platform 109 may constantly update the polling elements in accordance to the response received from UE 101. The one or more members of the group communication session may make suggestion on which group decision points to pick based on the preference information.

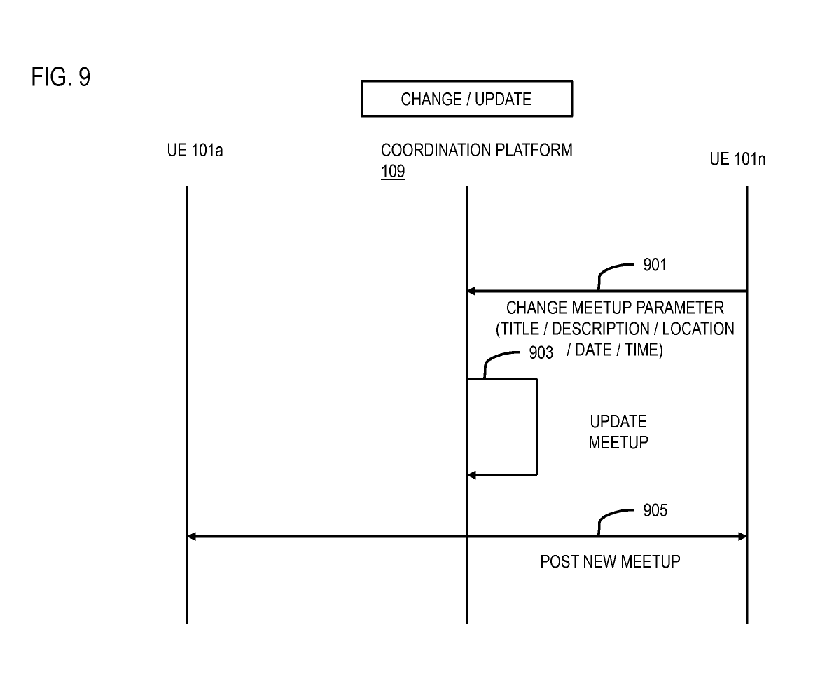

FIG. 9 is a ladder diagram that illustrates the sequence of process for changing or updating one or more group decision points based, at least in part, on user preference information during a group communication session. The coordination platform 109 provides UE 101n with the option to recommend new parameters or group decision points thereby replacing or updating the proposed one or more group decision points (step 901). In step 903, the coordination platform 109 processes the request to update the one or more group decision points. Subsequently, the coordination platform 109 displays the updated one or more group decision points to the member of a group communication session (Step 905). In one scenario, the new group decision points may be displayed right below the initial group decision points. In one scenario, the updated parameter may be displayed next to the one or more parameters for the one or more group decision points, for instance, a new time for the group decision points may be displayed alongside the old time.

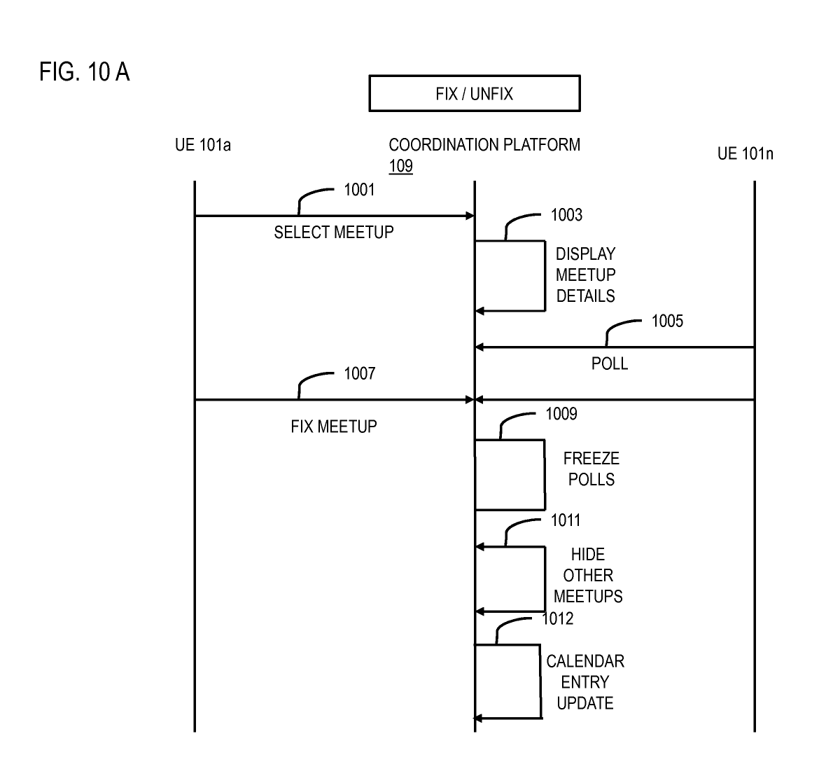

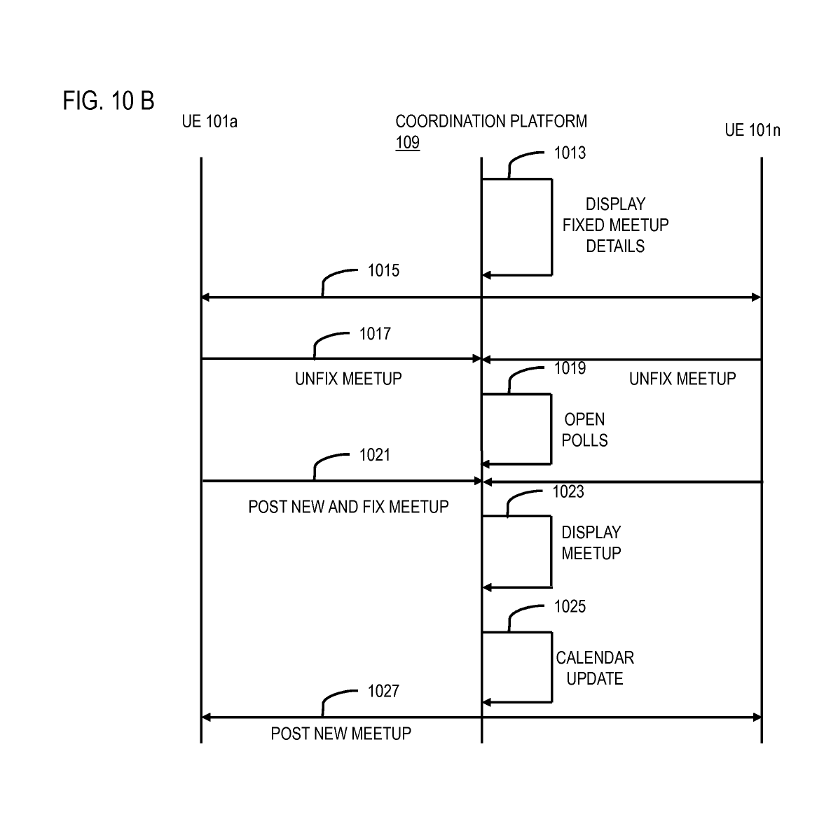

FIG. 10A is a ladder diagram that illustrates a sequence of process for determining preference information based, at least in part, on the one or more interactions, the one or more other interactions, or a combination thereof, thereby fixing the at least one outcome. In step 1001, the UE 101a selects a meetup and transmits the selection to the coordination platform 109. The coordination platform then causes a display of the selected meetup details (step 1003) and makes the details available to the UEs 101a and 101n. The UE 101n then expresses its preference for one or more sets of parameters for the meetup via, for instance, a polling mechanism (step 1005). In this example, after a period of polling, the UEs 101a and 101n mutually decide to fix the parameters of the meetup (step 1007). In one scenario, the coordination platform 109 may freeze polls from one or more members of the group communication session (step 1009) and may hide other one or more group decision points (step 1011) upon determining that at least one or more members of the group communication session ‘fixed’ at least one group decision point.

For example, if a meetup is due in an hour and majority of the participants have accepted, one of the participant can go ahead and finalize the group decision point, thereby hiding one or more of the at least one decision point user interface element, the at least one other decision point user interface element, or a combination thereof that are not associated with the fixed at least one outcome. Further, the coordination platform 109 may cause, at least in part, an entry of the fixed group decision point into an application (e.g., a calendar application) associated with the one or more members of the group communication session (Step 1012). Such entry may cause, at least in part, a notification of the group decision point based, at least in part, on the group decision point, application or a combination thereof.

FIG. 10B is a ladder diagram that illustrates a sequence of process whereby the coordination platform 109 causes a presentation of one or more notifications to the one or more members to indicate the fixing of the at least one outcome. In this example, the notification platform 109 causes a display of the fixed meetup details (step 1013) and notifies the participating UEs 101a and 101n (step 1015). In one embodiment, the notification may provide the members (e.g., the UEs 101a and 101n) with one or more options for unfixing the at least one outcome. In one scenario, any one or more members of the group communication session may ‘unfix’ a ‘fixed’ group decision point (Step 1017). Such action may result in the coordination platform 109 presenting one or more polling elements in the at least one decision point user interface element for determining an alternative group decision point (Step 1019). The one or more members of the group communication session may suggest and post new group decision points (step 1021). The suggested new group decision points may be fixed based, at least in part, on the preference information. (Step 1021). The newly fixed group decision point may replace the first group decision point and may be entered into an application associated with the one or more members of the group communication session. On agreeing to the parameters of the meetup of other group decision point, the notification platform 109 displays the new decision point or meetup details (step 1023) and updates related application entries (e.g., calendar entries) (step 1025). In addition, the notification platform 109 posts the new meetup or decision details to the group members (step 1027).

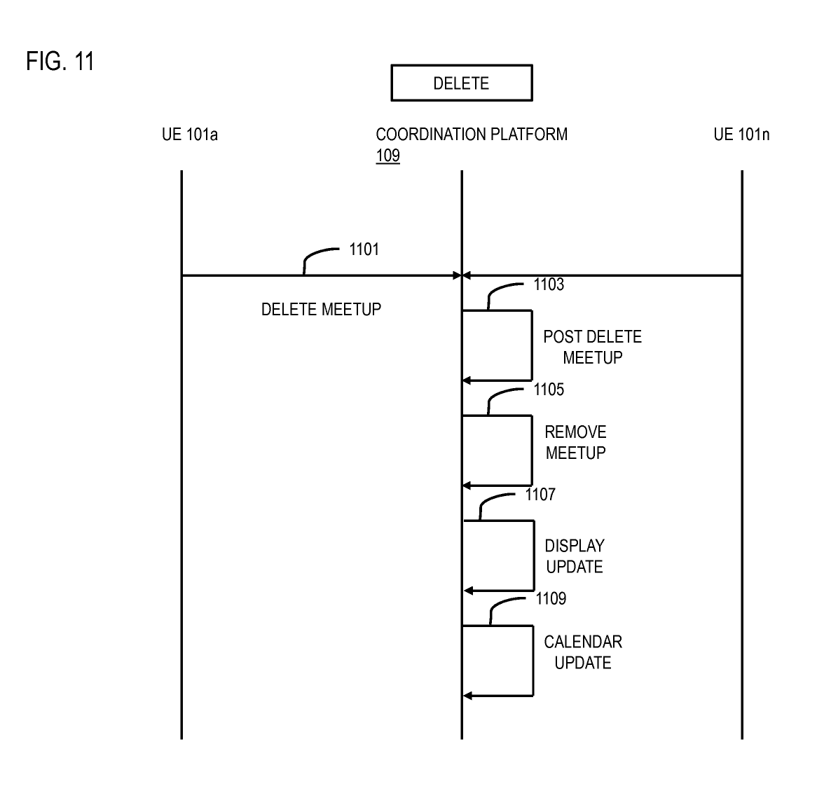

FIG. 11 is a ladder diagram that illustrates a sequence of process for cancelling a group decision point based, at least in part, on user preference information during a group communication session. In one scenario, any member to a group communication session may cancel a group decision point based, at least in part, on the preference information (step 1101), for instance, one or more member may delete the group decision point because other members to the group communication sessions did not poll in favor of the proposed group decision point. The coordination platform 109 may post the action by a member deleting the group decision point during the group conversation and may duly remove the determined or proposed group decision point from the conversation feed (steps 1103 and 1105). Then, the coordination platform 109 may display an updated status for the event and duly adjust the same in other applications (e.g., a calendar application) associated with the one or more members of the group communication session (steps 1107 and 1109).

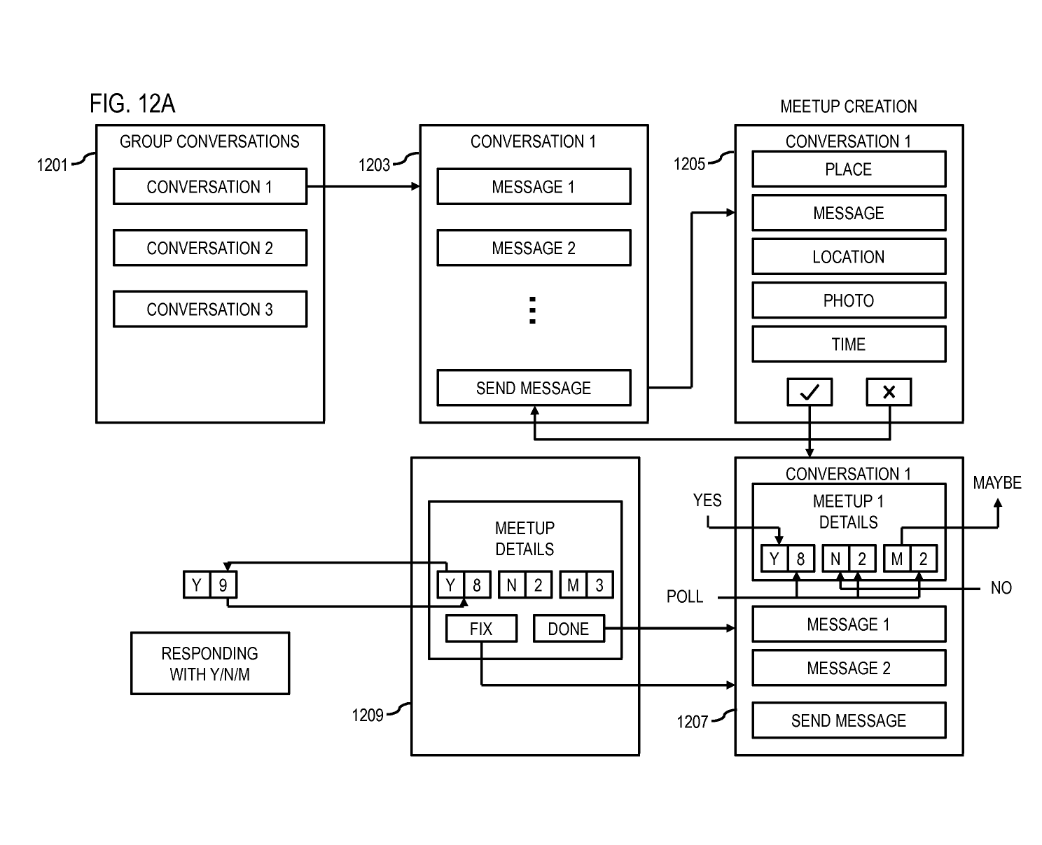

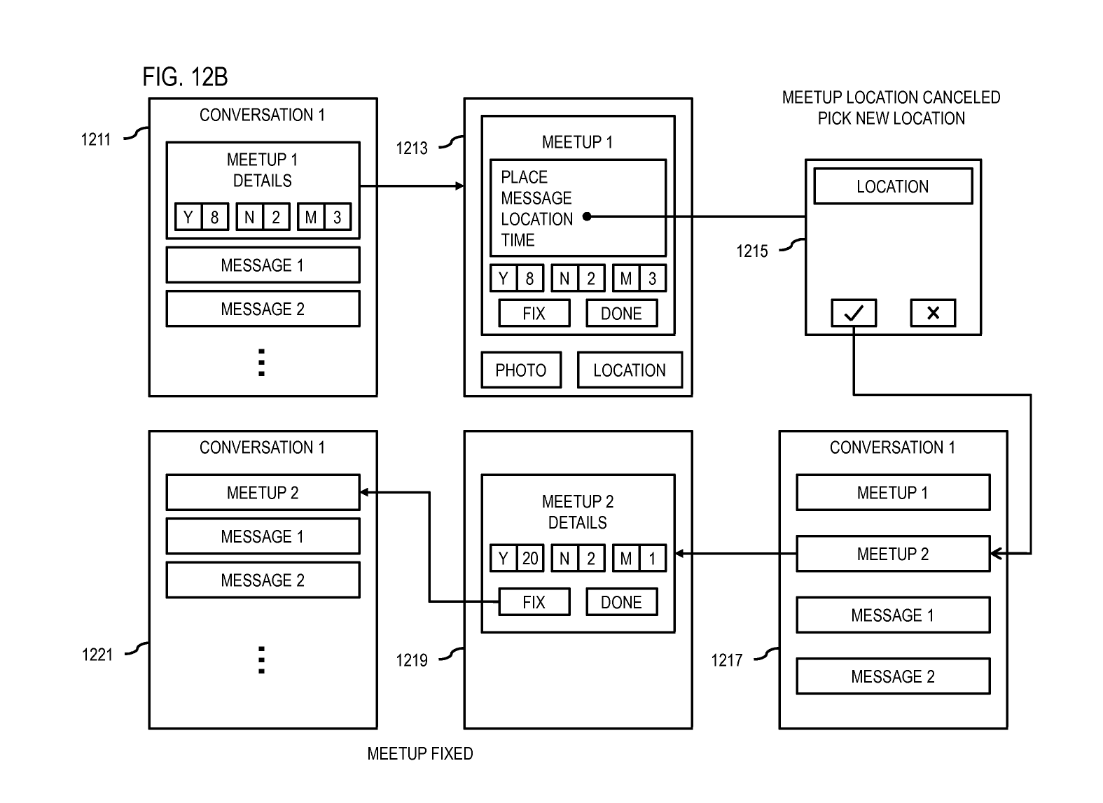

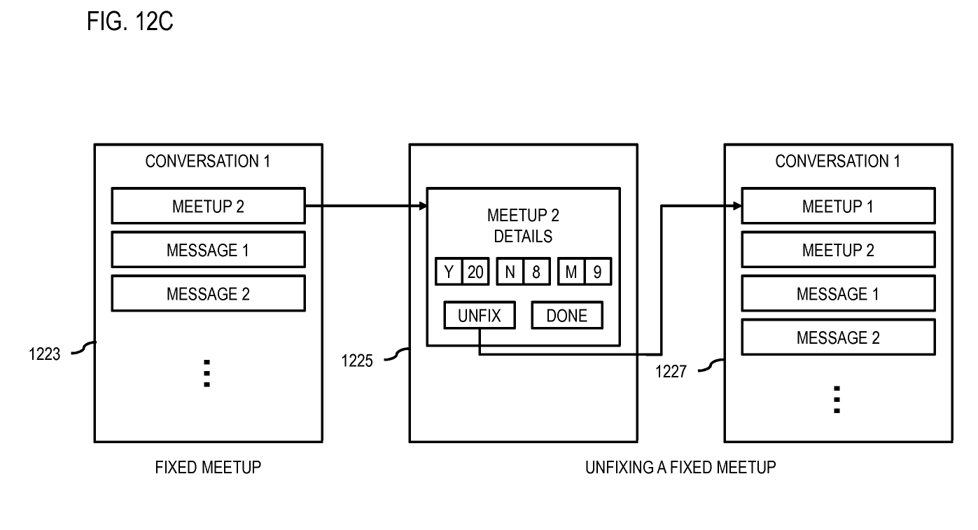

FIGS. 12A-12C are diagrams of user interfaces utilized in the processes of FIGS. 3-6, according to various embodiments. In one scenario, one or more members to a group communication session may initiate a conversation (as shown in user interface 1201) pertaining to a group decision point, whereby the coordination platform 109 may prompt the member to post messages and describe certain parameters for the proposed group decision point (as shown in use interface 1203). The user interface 1205 is a display of a set of parameters (for example, title, description, location, place, picture, date, time etc.) provided by the proposing member. Then, the coordination platform 109 may display the generated request of the proposed group decision point to the other participants in their respective conversation user interface, wherein the participants will be prompted to input their decision and/or suggestions. Subsequently, the user interface 1207 shows a layout wherein the group decision point is displayed alongside the preference information above the conversation between the one or more members to a group communication session. Further, one or more members are given an option to ‘fix’ or ‘unfix’ the group decision point based, at least in part, on the preference information (User Interface 1209).

FIG. 12B illustrates a method for changing one or more parameters associated with a group decision point. As illustrated, the coordination platform 109 present a user interface 1201 that displays meetup details that include member preference information (e.g., as shown via Yes votes, No votes, and Maybe votes) as shown in user interface 1211. The coordination platform 109 may then process one or more interactions (e.g., number of votes, views, etc.) with the meetup details presented in user interface 1211 to change, for instance, the location parameter and recommend a new location (user interfaces 1213 and 1215). Subsequently, the coordination platform 109 may fix at least one outcome based, at least in part, on the processing, for instance, the coordination platform 109 may cause a presentation of the group decision point with the new location parameter in the conversation feed for the users to fix it as shown the sequence of user interfaces 1217, 1219, and 1221.

FIG. 12C displays an option for the one or more members to ‘unfix’ the ‘fixed’ group decision point based, at least in part, on the preference information. For example, a meetup object containing the newly fixed meetup is presented in line with conversations of a group communication session as shown in user interface 1223. On selection of the meetup, the coordination platform 109 displays the details along with the preference information used to fix the meetup and an option to unfix the meetup (user interface 1225). If the option, to unfix the newly fixed meetup, the coordination platform 109 can revert the meetup object to display a previously fixed version of the meetup or one of the previously proposed options for the meetup as shown in user interface 1227.

The processes described herein for determining one or more group decision points based, at least in part, on user preference information during a group communication session may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

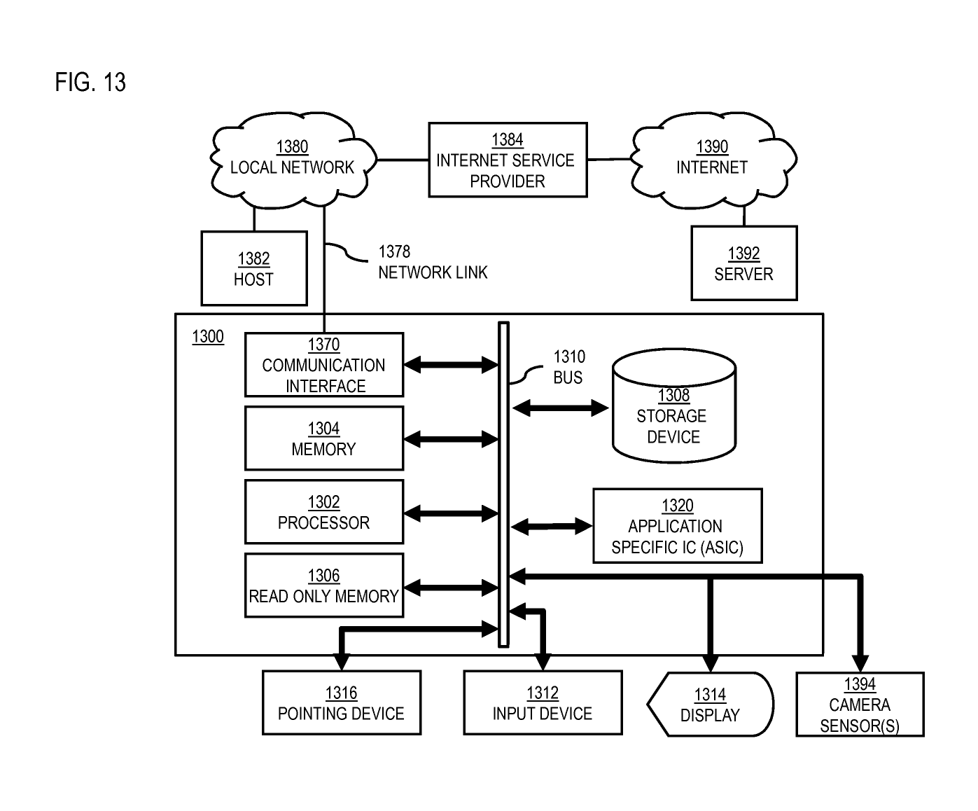

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to determine one or more group decision points based, at least in part, on user preference information during a group communication session as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of determining one or more group decision points based, at least in part, on user preference information during a group communication session.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to determine one or more group decision points based, at least in part, on user preference information during a group communication session. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RAM) or any other dynamic storage device, stores information including processor instructions for determining one or more group decision points based, at least in part, on user preference information during a group communication session. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for determining one or more group decision points based, at least in part, on user preference information during a group communication session, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 107 for determining one or more group decision points based, at least in part, on user preference information during a group communication session to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

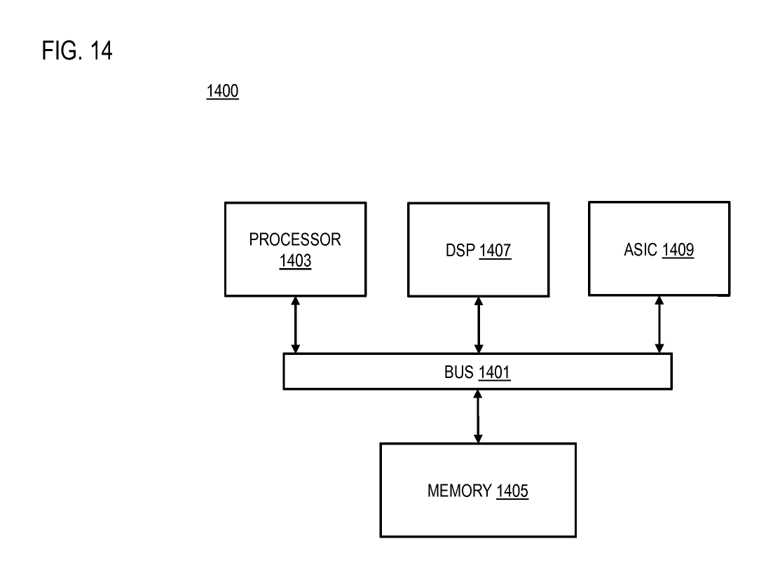

FIG. 14 illustrates a chip set or chip 1400 upon which an embodiment of the invention may be implemented. Chip set 1400 is programmed to determine one or more group decision points based, at least in part, on user preference information during a group communication session as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of determining one or more group decision points based, at least in part, on user preference information during a group communication session.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to determine one or more group decision points based, at least in part, on user preference information during a group communication session. The memory 1405 also stores the data associated with or generated by the execution of the inventive steps.

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of determining one or more group decision points based, at least in part, on user preference information during a group communication session. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of determining one or more group decision points based, at least in part, on user preference information during a group communication session. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to determine one or more group decision points based, at least in part, on user preference information during a group communication session. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of a request for presenting one or more group decision points in a conversation user interface of a group communication session;
a presentation of at least one decision point user interface element in the conversation user interface, wherein the at least one decision point user interface element presents one or more parameters associated with the one or more group decision points for one or more interactions by one or more members of the group communication session; and
a processing of the one or more interactions to cause, at least in part, a fixing of at least one outcome of the one or more group decision points for the one or more members.

2. A method of claim 1, wherein the (1) data and/or (2) information and/or (3) at least one signal are further based, at least in part, on the following:
a processing of the one or more interactions to determine an input for specifying one or more alternate values for the one or more parameters; and
a presentation of at least one other decision point user interface element,
wherein the at least one other decision point user interface element presents the one or more alternate values for the one or more parameters for one or more other interactions by the one or more members.

3. A method of claim 2, wherein the (1) data and/or (2) information and/or (3) at least one signal are further based, at least in part, on the following:
at least one determination of preference information for the one or more parameters, the one or more alternate values, or a combination thereof based, at least in part, on the one or more interactions, the one or more other interactions, or a combination thereof,
wherein the fixing of the at least one outcome is further based, at least in part, on the preference information.

4. A method of claim 3, wherein the (1) data and/or (2) information and/or (3) at least one signal are further based, at least in part, on the following:
a presentation of one or more polling elements in the at least one decision point user interface element, the at least one other decision point user interface element, or a combination thereof; and
at least one determination of the one or more interactions, the one or more other interactions, or a combination thereof with respect to the one or more polling elements.

5. A method of claim 3, wherein the fixing of the at least one outcome is based, at least in part, on a determination that the preference information indicates that the one or more members have reached at least one consensus threshold value with respect to the one or more group decision points.

6. A method of claim 2, wherein the (1) data and/or (2) information and/or (3) at least one signal are further based, at least in part, on the following:
a hiding of one or more of the at least one decision point user interface element, the at least one other decision point user interface element, or a combination thereof that are not associated with the fixed at least one outcome.

7. A method of claim 1, wherein the (1) data and/or (2) information and/or (3) at least one signal are further based, at least in part, on the following:
a presentation of one or more notifications to the one or more members to indicate the fixing of the at least one outcome,
wherein the one or more notifications include, at least in part, one or more options for unfixing the at least one outcome.

8. A method of claim 1, wherein the (1) data and/or (2) information and/or (3) at least one signal are further based, at least in part, on the following:
a parsing of conversation information presented in the conversation user interface to determine the request, the one or more parameters, or combination thereof.

9. A method of claim 1, wherein the one or more group decision points include, at least in part, one or more decisions related to coordinating a meetup among the one or more members.

10. A method of claim 9, wherein the one or more parameters include, at least in part, a location, a time, a description parameter, a lifetime parameter, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a request for presenting one or more group decision points in a conversation user interface of a group communication session;
cause, at least in part, a presentation of at least one decision point user interface element in the conversation user interface, wherein the at least one decision point user interface element presents one or more parameters associated with the one or more group decision points for one or more interactions by one or more members of the group communication session; and
process and/or facilitate a processing of the one or more interactions to cause, at least in part, a fixing of at least one outcome of the one or more group decision points for the one or more members.

12. An apparatus of claim 11, wherein the apparatus is further caused to:
process and/or facilitate a processing of the one or more interactions to determine an input for specifying one or more alternate values for the one or more parameters; and
cause, at least in part, a presentation of at least one other decision point user interface element,
wherein the at least one other decision point user interface element presents the one or more alternate values for the one or more parameters for one or more other interactions by the one or more members.

13. An apparatus of claim 12, wherein the apparatus is further caused to:
determine preference information for the one or more parameters, the one or more alternate values, or a combination thereof based, at least in part, on the one or more interactions, the one or more other interactions, or a combination thereof,
wherein the fixing of the at least one outcome is further based, at least in part, on the preference information.

14. An apparatus of claim 13, wherein the apparatus is further caused to:
cause, at least in part, a presentation of one or more polling elements in the at least one decision point user interface element, the at least one other decision point user interface element, or a combination thereof; and
determine the one or more interactions, the one or more other interactions, or a combination thereof with respect to the one or more polling elements.

15. An apparatus of claim 13, wherein the fixing of the at least one outcome is based, at least in part, on a determination that the preference information indicates that the one or more members have reached at least one consensus threshold value with respect to the one or more group decision points.

16. An apparatus of claim 12, wherein the apparatus is further caused to:
cause, at least in part, a hiding of one or more of the at least one decision point user interface element, the at least one other decision point user interface element, or a combination thereof that are not associated with the fixed at least one outcome.

17. An apparatus of claim 11, wherein the apparatus is further caused to:
cause, at least in part, a presentation of one or more notifications to the one or more members to indicate the fixing of the at least one outcome,
wherein the one or more notifications include, at least in part, one or more options for unfixing the at least one outcome.

18. An apparatus of claim 11, wherein the apparatus is further caused to:
cause, at least in part, a parsing of conversation information presented in the conversation user interface to determine the request, the one or more parameters, or combination thereof.

19. An apparatus of claim 11, wherein the one or more group decision points include, at least in part, one or more decisions related to coordinating a meetup among the one or more members.

20. An apparatus of claim 19, wherein the one or more parameters include, at least in part, a location, a time, a description parameter, a lifetime parameter, or a combination thereof.

21.-48. (canceled)
